(19) United States
(12) Patent Application Publication
(10) Pub. No.: US 2012/0246217 A1
(43) Pub. Date: Sep. 27, 2012

(54) SYSTEM AND METHOD INCLUDING WEB BROWSER RULES ENGINE FOR DATA ENTRY

(76) Inventors: ERIC D. SCHMIDT, Bridgeville, PA (US); Benjamin D. Farren, Bridgeville, PA (US); Brian A. Schultz, Pittsburgh, PA (US); Ronald J. Franke-Polz, Westerville, OH (US); Robert J. Teverino, Beaver, PA (US); Thomas G. Forsyth, IV, Monroeville, PA (US)

(21) Appl. No.: 13/053,674

(22) Filed: Mar. 22, 2011

(51) Int. Cl. G06F 15/16

(52) U.S. Cl. 709/203

(57) ABSTRACT

A system includes a web server having a server storage component including web page information, a rules engine, and a plurality of rules, and a client processor communicating with the web server over a global communication network. The client processor includes a processor component, a web browser, a web browser plug-in tool, and a processor storage component storing copies of the web page information, the rules engine, and the rules as downloaded from the server. The server embeds at least one of the rules engine and the rules with the web page information for download to the client processor. The rules establish a single valid data entry for a selected field of a web page for each combination of values for designated other fields of the web page. The rules engine executes the rules to select the single valid data entry dependent upon the values of the designated other fields.

### BACKGROUND

1. Field

The disclosed concept pertains generally to client-server systems and, more particularly, to systems that employ data entry, such as, for example and without limitation, bid manager systems. The disclosed concept also pertains to methods of data entry for a client-server system.

2. Background Information

A known bid manager configurator system is installed and operates locally at a user's computer. The system employs a rules engine and rule sets within a set of tools and processing applications installed on the user's computer. The system provides full rule sets and performs configuration activities without having access to the Internet. Since the system was developed in the early 1990s, it was designed to operate in an environment where Internet access was far from ubiquitous. However, there is a significant installation footprint on each user's computer. Also, providing new releases and updates for users necessitates the frequent publishing and distribution of system installation CDs. Furthermore, making rapid changes to product specifications, prices and other features for use by the system is difficult and expensive.

A current version of the bid manager configurator system is a Bid Manager Version 7.4 Release distributed by Eaton Corporation of Moon Township, Pa. The Bid Manager is a rules-based application that creates jobs, configures electrical products and services, prices bids, and packages quotes. With Bid Manager, the user can configure complex products, assemble a professional bill of material, and accurately price a job. Bid Manager contains a take-off application for each product that the user can configure. When preparing a bid, take-offs are employed to configure the product for a bid. When configuring a take-off, the options available or visible in the take-off depend on the selections that the user makes. As selections are made, the product rules and specifications built into the take-off will limit the windows and options within the take-off. A panelboard take-off is one non-limiting example. For example, if the user selects a specific bus ampere rating, then the panelboard type will change to reflect that choice.

U.S. Pat. No. 5,367,619 discloses a system for entering data to a digital computer program. The system integrates an expert system with electronic data forms. Essentially, at each field in an electronic data form, a rulebase is employed to ensure that the value entered by the user is valid in the context of the information entered up to that point. With this system, electronic data forms with complex interrelationships between fields and sub-forms can be developed, but there is no computer programming involved. All forms and fields are specified in a simple tabular format. The resultant electronic data forms provide the end user with a uniform interface which automatically validates input data, and ensures that values entered for each field are consistent with all other values. In addition to data entry forms, hypertext help forms can be displayed in a sequence which is variable dependent upon the data entered by the user. Only valid data entries consistent with previous entries can be made for the selected fields by the user. Fields which have only one valid data entry which is dependent upon entries made for designated other fields may be designated automatically. The entries for these fields can be automatically updated without user input when any value of the designated other fields is changed. Where the automatic field is a designated other field for additional automatic fields, the data entry system iteratively automatically enters the valid data entries for the additional automatic fields until a stable state is reached and no additional field values change.

The rulebase of U.S. Pat. No. 5,367,619 includes rules establishing the one valid entry for a selected field for each combination of values for designated other fields and an inference engine which fires the rules to select the one valid data entry dependent upon the values of the designated other fields. The expert system includes a table for each of the fields having only one valid data entry with each table including an input column for each of the designated other fields upon which the one valid entry for the selected field depends, an output column and successive rows, each containing in the input columns a combination of values for the designated other fields and in the output column the one valid data entry for the selected field for the values of the designated other fields in the input columns. Each row in this table constitutes a rule in the rulebase. A similar table is maintained for each field having a menu of valid outputs, with the output columns specifying the valid entries for each combination of input values in a row.

Microsoft® Silverlight® is an application framework for writing and running business and media applications (Rich Internet Applications (RIA)), with features and purposes similar to those of Adobe Flash™. The run-time environment for Silverlight® is available as a plug-in for most web browsers. Silverlight® can support streaming media, multimedia, graphics and animation, and gives developers support for Common Language Infrastructure (CLI) languages and development tools. A Microsoft®.xap file contains a complete bundle of application components to run a Silverlight® application either: (1) within a web page, or (2) locally on a user's processor when installed as an “out-of-browser” application. Silverlight® 4 supports WCF RIA services.

A RIA web application has many of the characteristics of desktop applications, typically delivered either by way of a site-specific browser, via a browser plug-in, independent sandboxes, or virtual machines. Adobe Flash™, Java®, and Microsoft® Silverlight® are examples of common platforms. Users generally need to install a software framework using the processor's operating system before launching the application, which typically downloads, updates, verifies and executes the RIA.

There is room for improvement in bid manager systems.

There is also room for improvement in methods of managing bids.

### SUMMARY

It is believed that operating a web version of the bid manager configurator by remotely running rules for configuration at a web server would significantly delay the timing for the user. It is desired to operate the rules locally at a client processor, without installing the rules locally, in order to be able to readily update product specifications, prices and other features while providing performance comparable to the known locally installed bid manager configurator. Hence, there is a need for a web version of the bid manager configurator, which can facilitate rapid changes to product specifications, prices and other features.

In accordance with one aspect of the disclosed concept, a system comprises: a web server comprising a server storage component including web page information, a rules engine, and a plurality of rules; and a client processor structured to communicate with the web server over a global communication network, the client processor comprising a processor component, a web browser, a web browser plug-in tool, and a processor storage component structured to store copies of the web page information, the rules engine, and the plurality of rules as downloaded from the web server over the global communication network, wherein the web server is structured to embed at least one of the rules engine and the plurality of rules with the web page information for download to the client processor over the global communication network, wherein the plurality of rules establish a single valid data entry for a selected field of a web page corresponding to the web page information for each combination of values for designated other fields of the web page, and wherein the rules engine executes the rules to select the single valid data entry dependent upon the values of the designated other fields.

In accordance with another aspect of the disclosed concept, a method of data entry for a client-server system comprises: employing a web server comprising a server storage component including web page information, a rules engine, and a plurality of rules; employing a client processor comprising a processor component, a web browser, a web browser plug-in tool, and a processor storage component; embedding at least one of the rules engine and the plurality of rules with the web page information before download to the client processor over a global communication network; downloading the web page information, the rules engine, and the plurality of rules to the client processor from the web server over the global communication network; storing copies of the downloaded web page information, the rules engine, and the plurality of rules in the processor storage component; establishing with the plurality of rules a single valid data entry for a selected field of a web page corresponding to the web page information for each combination of values for designated other fields of the web page, and executing the rules with the rules engine by the client processor to select the single valid data entry dependent upon the values of the designated other fields.

### BRIEF DESCRIPTION OF THE DRAWINGS

A full understanding of the disclosed concept can be gained from the following description of the preferred embodiments when read in conjunction with the accompanying drawings in which:

FIG. 1 is a block diagram of a bid manager system including a client processor and a web server interconnected by the Internet in accordance with the disclosed concept.

FIG. 2 is an example of a Microsoft®.xap file in accordance with the disclosed concept.

FIG. 3 is an example of a SSW.zip file, which contains rules data in accordance with the disclosed concept.

FIG. 4 is a block diagram of a data structure used to implement electronic form data entry for the system of FIG. 1.

FIG. 5 is an offline diagram of the client processor of FIG. 4.

### DESCRIPTION OF THE PREFERRED EMBODIMENTS

As employed herein, the term “number” shall mean one or an integer greater than one (i.e., a plurality).

As employed herein, the term “processor” shall mean a programmable analog and/or digital device that can store, retrieve, and process data; a computer; a workstation; a personal computer; a microprocessor; a microcontroller; a microcomputer; a central processing unit; a mainframe computer; a mini-computer; a server; a networked processor; or any suitable processing device or apparatus.

As employed herein, the term “client processor” shall mean a processor structured to communicate with a server over a communication network, such as a global communication network.

As employed herein, the term “web server” shall mean a processor structured to communicate with a client processor over a communication network, such as a global communication network.

The disclosed concept is described in association with a bid manager system, although the disclosed concept is applicable to a wide range of systems that provide data entry.

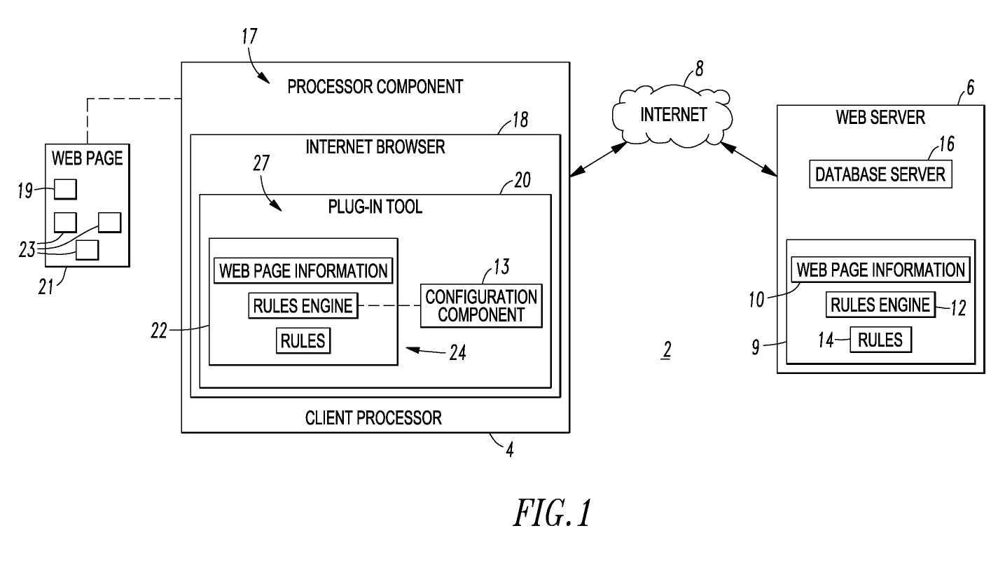

Referring to FIG. 1, a bid manager system 2 includes a client processor 4 of a user of the system 2 and a web server 6 interconnected with the client processor 4 by a global communication network, such as the Internet 8. The web server 6 includes a server storage component 9, which stores web page content, such as web page information 10, along with a rules engine 12 and a plurality of rules 14. As part of the web server 6, or as part of a separate server (not shown), a database server 16 stores and manages specific product configurations, options, and data and processing tools employed by the bid manager system 2. Also, the database server 16 stores and manages information related to various users' product configurations and activities. The client processor 4 includes a processor component 17, an Internet web browser 18 (e.g., without limitation, Internet Explorer®), a web browser plug-in tool (e.g., for graphics rendering) 20, and a downloaded copy 22 of the web page information 10, the rules engine 12, and the rules 14, as stored in local file and data storage 24.

As will be described, the web server 6 is structured to embed at least one of the rules engine 12 and the plurality of rules 14 with the web page information 10 for download to the client processor 4 over the Internet 8. The downloaded rules 14 establish a single valid data entry for a selected field 19 of a web page 21 corresponding to the web page information 10 for each combination of values for designated other fields 23 of the web page 21. The downloaded rules engine 12 executes the downloaded rules 14 to select the single valid data entry dependent upon the values of the designated other fields 23.

The disclosed system 2 employs various internal and external computer-based elements. The internal elements operate, for example, within a company's data centers (not shown), and have external connectivity via the Internet 8. Examples of the internal elements include: (1) the web application server 6 that transfers specific data and processing tools to the client processor 4 via Internet protocols; (2) the database server 16 that stores and manages the specific product configuration, options, and data and processing tools needed for successful operation; and (3) the database server 16 that stores and manages information related to users' product configurations and other activities.

Examples of the external elements that operate, for example, on the client processor 4 (e.g., without limitation, a personal computing device; web-enabled mobile device) include: (1) the Internet web browser 18; (2) the web browser plug-in tool 20 (e.g., without limitation, Microsoft® Silverlight®; Adobe Flash™) that provides capability for Rich Internal Application (RIA) 27 experiences; (3) additional tools and utilities (not shown) as provided from a prior connection to the web server 6; and (4) the local file and data storage 24.

The disclosed system 2 supports user interaction in two related, but distinct, ways. In a “connected” mode (FIG. 1), a user operates the client processor 4 with Internet connectivity to the web server 6 and/or other servers and systems, such as the database server 16. As the user performs activities related to configuration, pricing and negotiation, data moves from the client processor 4 and the web server 6 and/or other servers and systems based on the activities occurring.

The system 2 provides a bid management system including a configuration component 13 defined by the downloaded rules engine 12 and some of the plurality of downloaded rules 14.

The web server 6 is structured to: (1) embed the rules engine 12 within information including the web page information 10 for download to the client processor 4; (2) embed the rules engine 12 and the rules 14 within information including the web page information 10 for download to the client processor 4; and (3) embed the rules 14 within information including the web page information 10 for download to the client processor 4.

The database server 16 is structured to: (1) store and manage predefined standard product configurations employed by the bid management system 2; and (2) store and manage information related to custom product configurations from the client processor 4.

The web browser plug-in tool 20 is structured to provide the Rich Internet Application (RIA) Framework 27, and the client processor 4 is structured to execute the downloaded rules engine 12 within the Rich Internet Application (RIA) Framework 27. The client processor 4 is also structured to execute the downloaded web page information 10, including the rules engine 12 and access the plurality of rules 14, within the Rich Internet Application (RIA) Framework 27.

The client processor 4 is structured to receive a user request to download the web page information 10 and manage within the Rich Internet Application (RIA) Framework 27 downloading of the web page information 10, the rules engine 12 and the plurality of rules 14 from the web server 6 to the client processor 4 over the global communication network 8 without a subsequent user request.

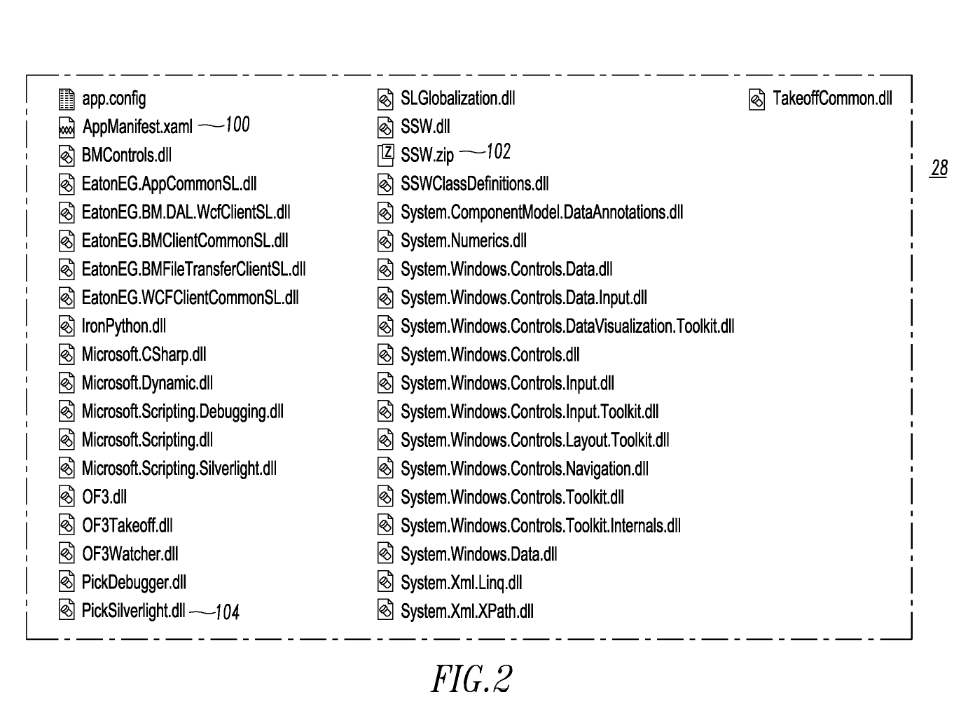

FIG. 2 shows a non-limiting example of a Microsoft®.xap file 28 in accordance with the disclosed concept. A Silverlight® control is a ZIP format file with extension .xap containing a list of one or more .NET managed assemblies (.dll files) along with an AppManifest.xaml file 100 containing this list along with the entry point (class and assembly). The XAML layout markup file (.xaml file) 100 can be augmented by code-behind code, written in any suitable .NET language, which contains the programming logic. It can be used to programmatically manipulate both the Silverlight® application and the HTML page which hosts the Silverlight® control. The XAML layout markup file 100, as well as the code, is compiled into .NET assemblies which are then compressed using ZIP and stored in the .xap file 28. The example Microsoft®.xap file 28 includes rules data in a <Rules>.zip (e.g., shown as SSW.zip) file 102, and a rules engine in the PickSilverlight.dll file 104.

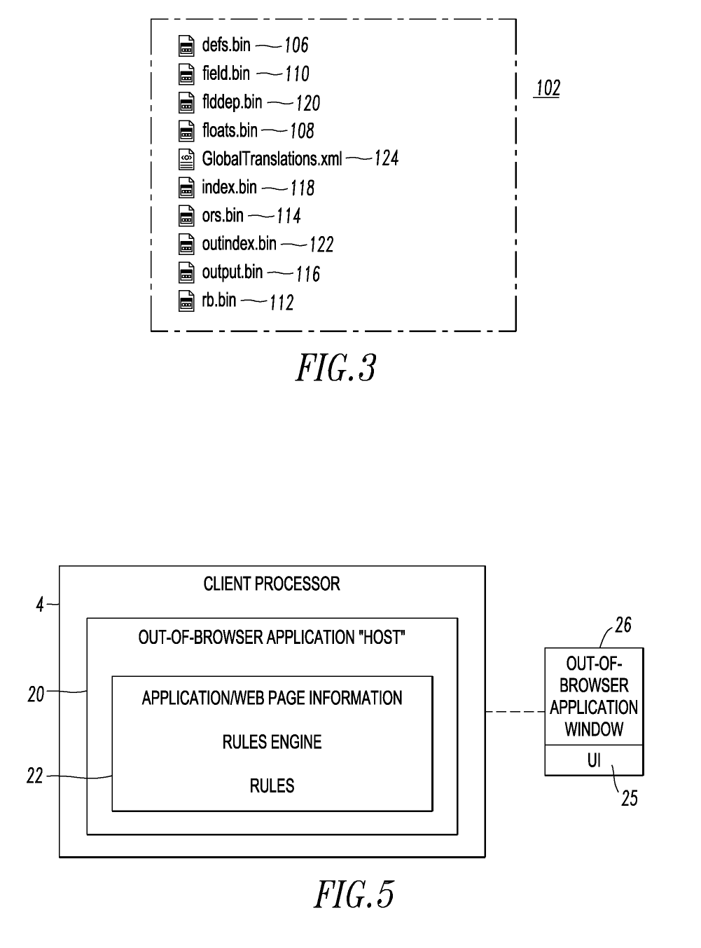

FIG. 3 shows the example SSW.zip file 102, which contains the rules 14. Rule “tables” are stored within the example SSW.zip file 102 as a series of binary .bin files, as defined by U.S. Pat. No. 5,367,619, which is incorporated by reference herein. As will be discussed, below, the disclosed system 2 employs the rules engine 12 and sets of rules 14 that provide virtually all of the constraint and selection rules for project configuration. An example of the rules engine 12 and rules 14 is disclosed by incorporated by reference U.S. Pat. No. 5,367,619. The rule “tables” are translated by a suitable knowledge compiler into compact integer tables in binary form. When a particular form is called, the form table is used to construct a data structure in memory 24 the client processor 4.

The sets of rules 14 (FIG. 1), or pick rules, are a collection of binary files which represent the table data. The binary files are created and organized in a specific pattern using the compiler.

The binary file defs.bin 106 contains the complete list of all “string” output values defined in the rules 14. Each value is assigned a unique identifier “token”, and establishes a lookup table for the strings. The file defs.bin 106 contains a list of employed alphanumeric values and integer codes. The alphanumeric values encoded include the values for all ALPHA type INPUT attributes for all rules in the system, and all values listed as elements of a disjunction definition. These integer codes are used to create a faster, more compact representation of the rule base and the disjunction definitions. Each disjunction definition is stored in the binary file ors.bin 114. The file consists of lists of disjunction definitions for every table in the system 2, each separated by a delimiter (e.g., corresponding to De12). The list of disjunction definitions for each table consists of the list of integer codes (from the binary file defs.bin 106) for the alphanumeric values of each of the elements of the disjunction. The list of codes for each disjunction is separated by a delimiter (e.g., corresponding to De11). The set of disjunctions for each table is referenced through the “ors index” in the binary file index.bin 118.

The INPUT of all the rules 14 in the expert system is stored in a compact form with no blanks, and in binary format in the binary file rb.bin 112. Each INPUT attribute value for every rule 14 is represented as an encoded operator/value pair, or operator/value/value triple in the case of RANGE type attributes. Operators (e.g., without limitation, < >,>=,<=) are encoded as integers, as are the values which are either the actual integer value for NUM and RANGE type attributes, or the integer codes (found in the file defs.bin 106) for ALPHA type attributes. The code −8888 represents, “don't care” (any value) and the code −9999 represents the end of a table.

The binary file floats.bin 108 contains the complete list of all floating-point numeric output values (rather than strings) defined in the rules 14. Each value is assigned a unique identifier “token”, and establishes a lookup table for the values.

The binary file field.bin 110 contains a lookup table of all table column header names. The file field.bin 110 contains a list of all the attributes of all the tables in the expert system. Each attribute name is listed followed by an integer code which indicates its TYPE (e.g., 2=ALPHA), followed by an integer code for its I/O type (e.g., 4=INPUT; 6=OUTPUT). All attributes for a given table are listed together, followed by a delimiter. The attribute list for a table can be found through the “field index” in the binary file index.bin 118.

The binary file rb.bin 112 is a combined list of all rules 14 or table rows. Each row value, or table cell, contains data pertaining to the type of rule operation to perform, and the input field value.

The binary file ors.bin 114 is a combined listing of all multi-value data items. This is used for representing more than one field value in a table cell.

The binary file output.bin 116 contains a listing of all output field values (results) indexed by rule number.

The binary file index.bin 118 contains a lookup table of all rule table names and the bit offsets to locate the items specified in the other binary files.

The binary file flddep.bin 120 contains one entry for each attribute in the system 2. An attribute's entry consists of the attribute name, followed by a list of tables in which that attribute appears as an INPUT attribute (table names separated by delimiters (e.g., corresponding to De11)). This list is followed by a second delimiter (e.g., corresponding to De12) which is then followed by a list of OUTPUT attributes which are directly dependent on this INPUT attribute (i.e., found in the tables in which this attribute is an INPUT attribute). Finally, the entry is followed by a third delimiter (e.g., corresponding to De13).

All delimiters specified in OUTPUT columns by the user are replaced in the file output.bin 116 by the system delimiter. For example, data corresponding to “a, b” is replaced by data corresponding to “a Ab”. This is employed since blanks are valid characters and therefore cannot be used as the delimiter character. Users can define their own delimiter character through a DEFINE DELIMITER: statement.

The binary file outindex.bin 122 contains indices which allow direct access to the output (in the binary file output.bin 116) of each rule 14 in the system 2. The file 122 contains one section for each table in the system 2. Each section is separated by data corresponding to a delimiter (Del). Within each section is a list of byte offset integers—one for each rule 14 in that table. The byte offset for a rule 14 is the number of bytes from the beginning of that table's section in the binary file output.bin 116 at which the output for the given rule 14 begins. The entries for each table in the binary file outindex.bin 122 are referenced through the table's “outindex index” in the binary file index.bin 118.

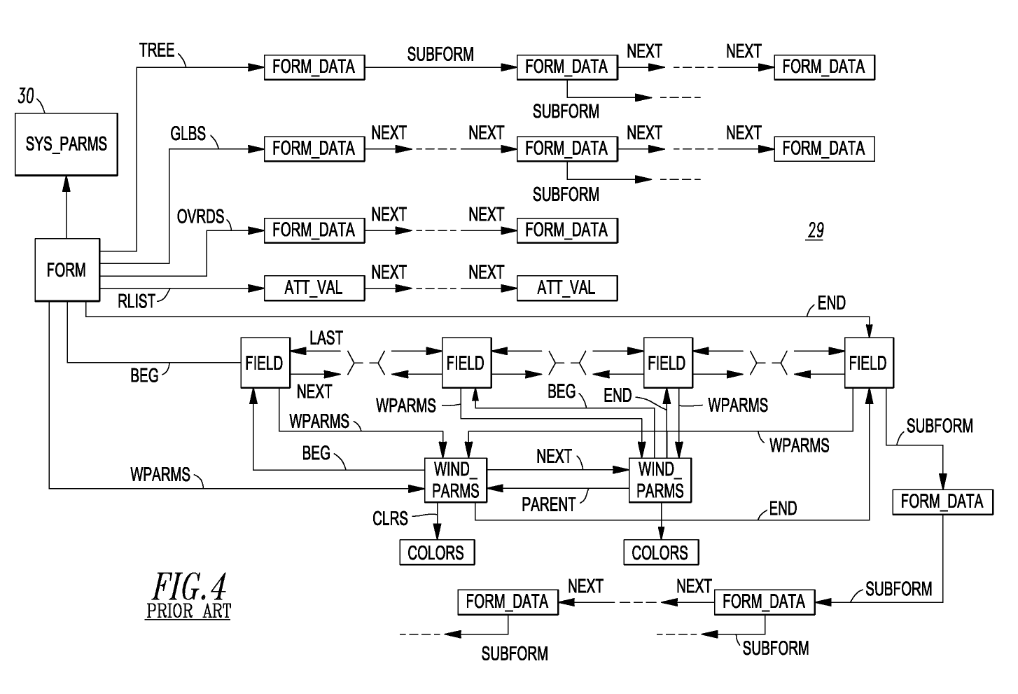

The file GlobalTranslations.xml 124 provides translations of the rule outputs to other languages (e.g., without limitation, French; Spanish; Dutch). A data structure 29 (FIG. 4) comprises a number of data cells linked by pointers. A systems parameter cell 30 contains parameters common to the hierarchy to which a corresponding form belongs. This cell 30 stores the current execution mode whether interactive, validate, automatic, or hypertext. It also stores the name of the next hypertext form to be called if the user asks for help. It further stores a restricted scope indicator for hybrid forms. The systems parameter cell 30 also stores a cursor pointing device (e.g., without limitation, mouse) mode indicator indicating whether the mouse is active and a highlight violations indicator indicating whether highlight violations option has been selected. Systems parameter cell 30 further includes an override precedence indicator.

There are three lists by which the value of a field on a form can be set by values from another form: a global list, a tree list and an override list. The override precedent establishes which value will prevail if a field is on more than one list. Also the systems parameter cell 30 stores an audit type selection which is used in leaving a form to determine whether all forms, in the hierarchy should be validated, only the top form, or none of the forms in which case a form could be exited with inconsistent data in the fields.

Referring to FIG. 5, in a “disconnected” (or offline) mode, the user operates the client processor 4 without having any connectivity to the web server 6 (FIG. 1). The client processor 4 includes, for example and without limitation, a Silverlight® out-of-browser application “host” 20. Silverlight® applications can be configured in order that users can install them from a host web page and run them outside of the web browser 18 of the client processor 4 (FIG. 1). Configuration involves providing additional information about an application. Silverlight® uses this information to display an installation user interface (UI) 25 having shortcuts (not shown) for launching the application, and an out-of-browser application window 26. This information is supplied through the application manifest, in order that out-of-browser support can be enabled in an existing application without rebuilding. Such an out-of-browser application can run without a network (e.g., Internet 8 of FIG. 1) connection. The Silverlight® out-of-browser application “host” 20 runs the application, which includes the web page information 10, the rules engine 12 and the rules 14 of FIG. 1. The rules .bin files of FIG. 3 are cached in the local file and data storage 24 of the client processor 4 after first visiting the online site via the web server 6. The RIA Framework 27 caches files for offline use. For example, this function is provided by the “Isolated Storage” feature in the Silverlight® Framework, which enables the client processor 4 to execute the configuration component 13 within the RIA Framework 27 without connectivity between the web server 6 and the client processor 4 over the Internet 8.

The disclosed system 2 enables the user to complete certain subsets of configuration activities without a connection to the web server 6 and/or other servers and systems, such as the database server 16. This enables both extended range of use in the disconnected mode (FIG. 5) and significant performance enhancements overall since the need to exchange data between the client processor 4 and the web server 6 is significantly reduced.

The disclosed system 2 can employ relatively high speed Internet capability by leveraging the Internet 8 to provide a system solution to deliver an up-to-date, accurate user experience, and relatively more agility in provisioning, support and upgrading of the system 2 (e.g., conveniently at the single database server 16 as opposed to at a plurality of disparately located user processors (not shown)). However, a contrary factor is the desire to maintain some level of operational capability for users when Internet connectivity is not available. This means that the disclosed system 2 leverages the Internet 8, but is not wholly depend on its availability. As a result, some part of the system 2 is stored and executed on the client processor 4 in the “disconnected” mode (FIG. 5).

The disclosed system 2: (1) employs the rules engine 12 and rules 14 of U.S. Pat. No. 5,367,619 in an embedded mode with web page information 10 sent via Internet protocols; (2) embeds the rules 14 within the web page information 10 transferred to the client processor 4; (3) embeds the rules engine 12 within the information transferred to the client processor as part of the web page information 10; (4) executes the rules engine 12, embedded within the web page information 10, within the Rich Internet Application (RIA) Framework 27; (5) accesses the rules 14 by the rules engine 12 for execution within the RIA Framework 27; (6) executes the web page information 10 within the RIA Framework 27; (7) executes bid manager configuration activities within the RIA Framework 27 without the need for Internet connectivity, thereby improving performance and extending the utility of the system 2; and (8) internally manages the mechanisms for the transfer of the rules engine 12 and the rules 14 within the RIA Framework 27 and the web page information 10.

The disclosed system 2 includes a processor-based software application that provides, for example, product configuration capability. For example, the activity of product configuration includes users interacting with the system 2, using visually-based graphical elements (e.g., without limitation, buttons; sliders; selectors; drawing tools) that allow for: (1) design and specification of equipment structures and enclosures to contain sub-assemblies and equipment components; (2) specification of electrical and mechanical characteristics of assemblies, subsystems and components; (3) arrangement and placement of assemblies, subsystems and components within structures and enclosures; (4) specification of labeling and identification information; and (5) other specific configuration specifications, including assembly instructions.

Non-limiting examples of products that can be configured by the system 2 include electrical power distribution equipment, electrical power quality systems, and service and support configurations. The products that can be configured can include items whose specific configuration has been previously manufactured, or products whose specific configuration has not been previously manufactured.

The disclosed system 2 also provides example mechanisms for presenting additional information related to the product, including price-related information, additional business activity workflow processing, including requests for specific pricing levels, negotiation management, and other business activities related to successful design, configuration, negotiation, manufacture, testing, delivery and installation of products.

While specific embodiments of the disclosed concept have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the disclosed concept which is to be given the full breadth of the claims appended and any and all equivalents thereof.

What is claimed is:

1. A system comprising:
a web server comprising a server storage component including web page information, a rules engine, and a plurality of rules; and
a client processor structured to communicate with said web server over a global communication network, said client processor comprising a processor component, a web browser, a web browser plug-in tool, and a processor storage component structured to store copies of the web page information, the rules engine, and the plurality of rules as downloaded from said web server over the global communication network,
wherein said web server is structured to embed at least one of the rules engine and the plurality of rules with the web page information for download to said client processor over the global communication network,
wherein said plurality of rules establish a single valid data entry for a selected field of a web page corresponding to the web page information for each combination of values for designated other fields of said web page, and
wherein said rules engine executes said rules to select the single valid data entry dependent upon the values of the designated other fields.

2. The system of claim 1 wherein said web server is structured to embed the rules engine within information including the web page information for download to said client processor.

3. The system of claim 2 wherein the web browser plug-in tool is structured to provide a Rich Internet Application Framework; and wherein said client processor is structured to execute the rules engine within said Rich Internet Application Framework.

4. The system of claim 1 wherein said web server is structured to embed the rules engine and the plurality of rules within information including the web page information for download to said client processor.

5. The system of claim 4 wherein the web browser plug-in tool is structured to provide a Rich Internet Application Framework; and wherein said client processor is structured to execute the rules engine and access the plurality of rules within said Rich Internet Application Framework.

6. The system of claim 5 wherein said client processor is structured to receive a user request to download the web page information; and
wherein said client processor and said web server are cooperatively structured to manage within said Rich Internet Application Framework downloading of the web page information, the rules engine, and the plurality of rules from said web server to said client processor over the global communication network without a subsequent user request.

7. The system of claim 1 wherein said web server is structured to embed the plurality of rules within information including the web page information for download to said client processor.

8. The system of claim 1 wherein the web browser plug-in tool is structured to provide a Rich Internet Application Framework; and wherein said client processor is structured to execute the web page information within said Rich Internet Application Framework.

9. The system of claim 1 wherein the web browser plug-in tool is structured to provide a Rich Internet Application Framework; wherein said system is a bid management system including a configuration component defined by the rules engine and some of the plurality of rules; and wherein said client processor is structured to execute the configuration component within the RIA Framework without connectivity between said web server and said client processor over the global communication network.

10. The system of claim 1 wherein said system is a bid management system.

11. The system of claim 10 wherein said web server comprises a database server structured to store and manage predefined standard product configurations employed by said bid management system.

12. The system of claim 11 wherein the database server is further structured to store and manage information related to custom product configurations from said client processor.

13. A method of data entry for a client-server system comprising:
employing a web server comprising a server storage component including web page information, a rules engine, and a plurality of rules;
employing a client processor comprising a processor component, a web browser, a web browser plug-in tool, and a processor storage component;
embedding at least one of the rules engine and the plurality of rules with the web page information before download to said client processor over a global communication network;
downloading the web page information, the rules engine, and the plurality of rules to said client processor from said web server over the global communication network;
storing copies of the downloaded web page information, the rules engine, and the plurality of rules in the processor storage component;
establishing with the plurality of rules a single valid data entry for a selected field of a web page corresponding to the web page information for each combination of values for designated other fields of said web page, and
executing said rules with said rules engine by said client processor to select the single valid data entry dependent upon the values of the designated other fields.
